(19) United States
(12) Patent Application Publication
(10) Pub. No.: US 2010/0092656 A1
(43) Pub. Date: Apr. 15, 2010

(54) PRINTABLE IONIC STRUCTURE AND METHOD OF FORMATION

(75) Inventor: Michael N. Kozicki, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: AXON TECHNOLOGIES CORPORATION, Scottsdale, AZ (US)

(21) Appl. No.: 12/576,515

(22) Filed: Oct. 9, 2009

Related U.S. Application Data
(60) Provisional application No. 61/104,595, filed on Oct. 10, 2008.

(51) Int. Cl. B05D 5/12

(52) U.S. Cl. 427/58

(57) ABSTRACT

An ionic structure, including a plurality of electrodes and an ion conductor, wherein at least one of the electrodes and the ion conductor is formed using a printing technique and a method of forming and using the structure are disclosed. Electrical properties of the structure may be altered by applying energy to the structure, and thus information may be stored using the structure. The structure may also be used to form an electrical connection within portions of a device and/or between devices.

### CROSS REFERENCE TO RELATED APPLICATIONS

This Application claims the benefit of Provisional Application No. 61/104,595, filed Oct. 10, 2008, entitled PRINTABLE INORGANIC MEMORY DEVICE AND METHOD OF FORMATION.

### FIELD OF INVENTION

The present invention generally relates to ionic structures and devices. More particularly, the invention relates to ionic structures having an electrical property that can be variably programmed by manipulating an amount of energy supplied to the structure and to devices including the structures.

### BACKGROUND OF THE INVENTION

Programmable structures are often used in electronic systems and computers for a variety of applications. For example, programmable structures may be used in memory devices to store information in the form of binary data. These memory devices may be characterized into various types, each type having associated with it various advantages and disadvantages.

For example, random access memory (“RAM”), which may be found in personal computers, is typically volatile semiconductor memory; in other words, the stored data is lost if the power source is disconnected or removed. Dynamic RAM (“DRAM”) is particularly volatile in that it must be “refreshed” (i.e., recharged) every few hundred milliseconds in order to maintain the stored data. Static RAM (“SRAM”) will hold the data after one writing so long as the power source is maintained; once the power source is disconnected, however, the data is lost. Thus, in these volatile memory configurations, information is only retained so long as the power to the system is not turned off. In general, these RAM devices can take up significant chip area and therefore may be expensive to manufacture and consume relatively large amounts of energy for data storage. Accordingly, improved memory devices suitable for use in personal computers and the like are desirable.

Other storage devices such as magnetic storage devices (e.g., hard disks and magnetic tape) as well as other systems, such as optical disks, CD-RW and DVD-RW are non-volatile, have extremely high capacity, and can be rewritten many times. Unfortunately, these memory devices are physically large, are shock/vibration-sensitive, require expensive mechanical drives, and may consume relatively large amounts of power. These negative aspects make such memory devices non-ideal for low power portable applications such as lap-top and netbook computers, personal digital assistants (“PDAs”), and the like.

Due, at least in part, to a rapidly growing number of compact, low-power portable computer systems and hand-held appliances in which stored information changes regularly, low energy read/write semiconductor memories have become increasingly desirable and widespread. Furthermore, because these portable systems often require data storage when the power is turned off, non-volatile storage devices are desired for use in such systems.

One type of programmable semiconductor non-volatile memory device suitable for use in such systems is a programmable read-only memory (“PROM”) device. One type of PROM, a write-once read-many (“WORM”) device, uses an array of fusible links. Once programmed, the WORM device cannot be reprogrammed.

Other forms of PROM devices include erasable PROM (“EPROM”) and electrically erasable PROM (EEPROM) devices, which are alterable after an initial programming. EPROM devices generally require an erase step involving exposure to ultra violet light prior to programming the device. Thus, such devices are generally not well suited for use in portable electronic devices. EEPROM devices are generally easier to program, but suffer from other deficiencies. In particular, EEPROM devices are relatively complex, are relatively difficult to manufacture, and are relatively large. Furthermore, a circuit including EEPROM devices must withstand the high voltages necessary to program the device. Consequently, EEPROM cost per bit of memory capacity is extremely high compared with other means of data storage. Another disadvantage of EEPROM devices is that, although they can retain data without having the power source connected, they require relatively large amounts of power to program. This power drain can be considerable in a compact portable system powered by a battery.

Various hand-held appliances such as PDAs, smart phones, and the like as well as other electronic systems generally include a memory device coupled to a microprocessor and/or microcontroller formed on a separate substrate. For example, portable computing systems include a microprocessor and one or more memory chips coupled to a printed circuit board.

Forming memory devices and the microprocessor on separate substrates may be undesirable for several reasons. For example, forming various types of memory on separate substrate may be relatively expensive, may require relatively long transmission paths to communicate between the memory devices and any associated electronic device, and may require a relatively large amount of room within a system.

Accordingly, memory structures that may be formed on the same substrate as another electronic device and methods of forming the same are desired. Furthermore, this memory technology desirably operates at a relatively low voltage while providing high speed memory with high storage density and a low manufacturing cost.

Programmable structures may also be used to form interconnects, as disclosed in U.S. Pat. No. 6,469,364, entitled PROGRAMMABLE INTERCONNECTION SYSTEM FOR ELECTRICAL CIRCUITS, issued to Kozicki on Oct. 22, 2002. Similarly, such structures may be used to repair electrical lines, as disclosed in U.S. Pat. No. 6,388,324, entitled SELF-REPAIRING INTERCONNECTIONS, issued to Kozicki on May 14, 2002. For example, programmable structures may be used to form an electrical connection within a metal layer of a device, between two or more metal layers within a device, and/or between separately-formed wafers, devices, or other structures.

### SUMMARY OF THE INVENTION

The present invention provides ionic structures and devices and methods of forming the same. The structures may be used to form memory devices, to form electrical connections between portions of a device, to form electrical connections between devices, and the like.

The ways in which the present invention addresses various drawbacks of now-known programmable structures are discussed in greater detail below. However, in general, the present invention provides an ionic structure that is relatively easy and inexpensive to manufacture and which is formed, at least in part, using a printing process.

In accordance various embodiments of the present invention, an ionic structure includes an ion conductor and at least two electrodes, wherein at least one of the electrodes and the ion conductor is formed using printing technology. Using printing technology to form part of the ionic structure allows for low-cost, high-volume manufacturing of the structures and devices including the structures. Such techniques also allow for formation of the structures on a variety of surfaces and substrates, including flexible substrates.

An ionic structure in accordance with various exemplary embodiments is configured such that when a bias is applied across two electrodes, one or more electrical properties of the structure change. In accordance with exemplary aspects of these embodiments, a resistance across the structure changes when a bias is applied across the electrodes. In accordance with other aspects, a capacitance or other electrical property of the structure changes upon application of a bias across the electrodes. In accordance with further aspects, an amount of change in the programmable property is manipulated by altering (e.g., thermally, electrically, or photonically) an amount of energy used to program the device. One or more of these electrical changes and/or the amount of change may be used to form an electrical connection (or break) between portions of a device, between devices, chip to chip, chip to package, package to package, package to printed circuit board, printed circuit board to printed circuit board, device/chip/package/board connections to wiring or flexible circuits, any combination thereof, and the like. Similarly, in the case of memory devices, the electrical changes and/or the amount of change may suitably be detected.

In accordance with additional exemplary embodiments of the invention, an ionic structure includes an ion conductor, at least two electrodes, and a barrier interposed between at least a portion of one of the electrodes and the ion conductor, wherein at least one of the electrodes, the ion conductor, and the barrier is formed using printing techniques. In accordance with one aspect of this embodiment, the barrier material includes a material configured to reduce diffusion of ions between the ion conductor and at least one electrode. In accordance with another aspect, the barrier material includes an insulating or high-resistance material. In accordance with yet another aspect of this embodiment, the barrier includes material that conducts ions, but which is relatively resistant to the conduction of electrons.

In accordance with another exemplary embodiment of the invention, an ionic structure is formed on a surface of a substrate by forming a first electrode on the substrate, depositing a layer of ion conductor material over the first electrode, and depositing conductive material onto the ion conductor material wherein at least one of the first electrode, the ion conductor, and the conductive material is deposited using printing technology. In accordance with one aspect of this embodiment, a solid solution including the ion conductor and excess conductive material is formed by dissolving (e.g., via thermal and/or photodissolution) a portion of the conductive material in the ion conductor. In accordance with a further aspect, only a portion of the conductive material is dissolved, such that a portion of the conductive material remains on a surface of the ion conductor to form an electrode on a surface of the ion conductor material. In accordance with another aspect of this embodiment of the invention, a structure including a high-resistance region is formed by dissolving a portion of the conductive material, such that a portion of the ion conductor includes a high concentration of the conductive material and another portion of the ion conductor includes a low concentration of the conductive material, such that the portion of the ion conductor with a low concentration of the conductive material forms a high resistance region within the structure. In accordance with another aspect, the ionic structure is formed on a surface of a flexible substrate.

In accordance with another exemplary embodiment of the invention, an ionic structure is formed on a surface of a substrate by forming an ion conductor material over a substrate, forming a first electrode over a portion of the ion conductor and forming a second electrode over a portion of the ion conductor, wherein at least one of the first electrode, the ion conductor, and the second electrode is deposited using printing technology. In accordance with one aspect of this embodiment, a solid solution including the ion conductor and excess conductive material is formed by dissolving (e.g., via thermal and/or photodissolution) a portion of the conductive material in the ion conductor. In accordance with a further aspect, only a portion of the conductive material is dissolved, such that a portion of the conductive material remains on a surface of the ion conductor to form an electrode on a surface of the ion conductor material. In accordance with another aspect of this embodiment of the invention, a structure including a high-resistance region is formed by dissolving a portion of the conductive material, such that a portion of the ion conductor includes a high concentration of the conductive material and another portion of the ion conductor includes a low concentration of the conductive material, such that the portion of the ion conductor with a low concentration of the conductive material, forms a high resistance region within the structure. In accordance with another aspect, the ionic structure is formed on a surface of a flexible substrate.

In accordance with a further exemplary embodiment of the invention, multiple bits of information are stored in a single programmable structure.

In accordance with yet another embodiment of the invention, multiple programmable devices are coupled together using a common electrode (e.g., a common anode or a common cathode).

In accordance with yet another embodiment of the invention, a volatility of an ionic structure in accordance with the present invention is manipulated by altering an amount of energy used during a write process for the memory. In accordance with this embodiment of the invention, higher energy is used to form nonvolatile memory, while lower energy is used to form volatile memory. Thus, a single memory device, formed on a single substrate, may include both nonvolatile and volatile portions. In accordance with a further aspect of this embodiment, the relative volatility of one or more portions of the memory may be altered at any time by changing an amount of energy supplied to a portion of the memory during a write process.

In accordance with an additional embodiment of the invention, the structures include an additional conductive layer proximate one or more of the electrodes to increase the speed of the formation of the region with an altered electrical property.

### BRIEF DESCRIPTION OF THE DRAWINGS

A more complete understanding of the present invention may be derived by referring to the detailed description and claims, considered in connection with the figures, wherein like reference numbers refer to similar elements throughout the figures, and:

FIGS. 1A and 1B illustrate a lateral ionic structure in accordance with exemplary embodiments of the invention; and

FIG. 2 illustrates a cross-sectional view of a vertical ionic structure in accordance with additional embodiments of the present invention.

Elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

The present invention generally relates to ionic structures and devices and to methods of forming and using the structures and devices.

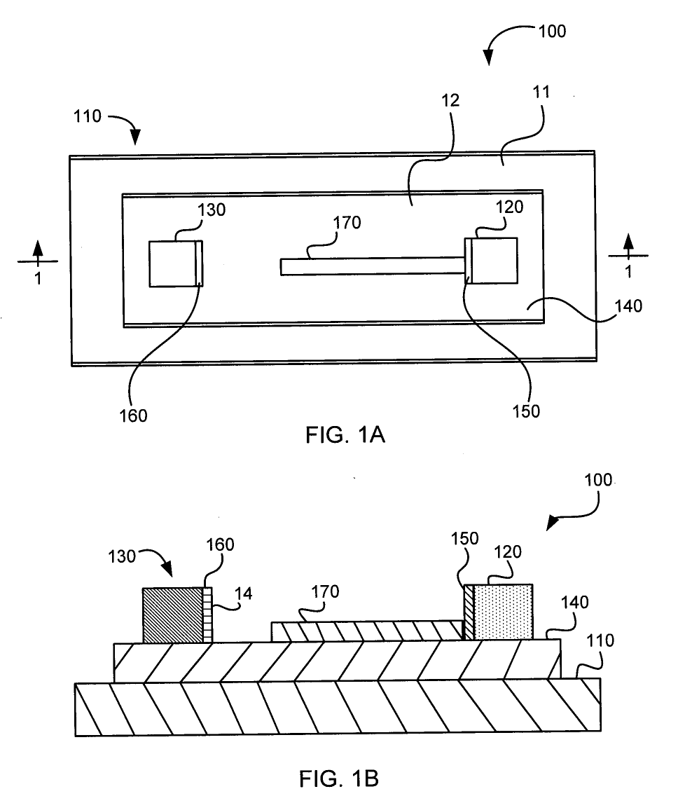

FIGS. 1A and 1B illustrate a horizontal or lateral configuration of an ionic structure 100 formed on a surface of a substrate 110 in accordance with an exemplary embodiment of the present invention. Structure 100 includes electrodes 120 and 130, an ion conductor 140, and optionally includes buffer or barrier layers or regions 150 and/or 160.

Generally, an ionic structure in accordance with various embodiments of the invention, such as structure 100, is configured such that when a bias greater than a threshold voltage (V_{T}), discussed in more detail below, is applied across electrodes 120 and 130, the electrical properties of structure 100 change. For example, in accordance with one embodiment of the invention, as a voltage V≧V_{T} is applied across electrodes 120 and 130, conductive ions within ion conductor 140 begin to migrate and form a region 170 having an altered conductivity compared to the bulk ion conductor (e.g., an electrodeposit) at or near one of electrodes 120 and 130. As region 170 forms, the resistance between electrodes 120 and 130 decreases and other electrical properties may also change. Although illustrated with region 170 formed on a surface of ion conductor 140, region 170 may be partially or entirely formed within ion conductor 140.

In the absence of any barriers, which are discussed in more detail below, the threshold voltage required to grow region 170 from one electrode toward the other and thereby significantly reduce the resistance of the device is approximately a few hundred millivolts. If the same voltage is applied in reverse, region 170 will dissolve back into the ion conductor and the device will return to a high resistance state. In a similar fashion, an effective barrier height of a diode that forms between an ion conductor and an electrode can be reduced by growing region 170; thus current flow may be increased through the structure, even if the resistance of the structure is substantially the same.

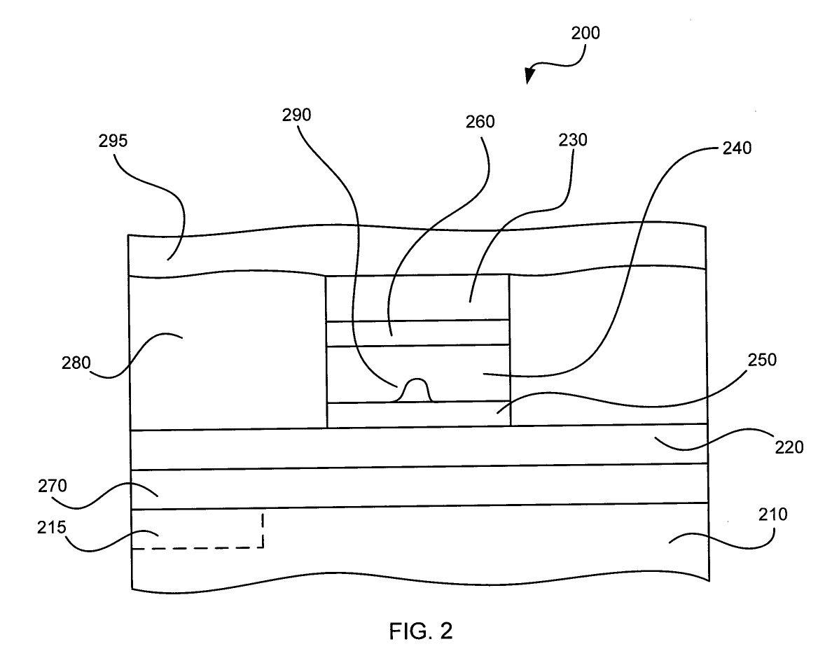

FIG. 2 illustrates a vertical ionic structure 200 in accordance with additional embodiments of the invention. Similar to structure 100, structure 200 is formed on a surface of a substrate 210 and includes electrodes 220, 230, ion conductor 240, and optional barrier/buffer layers 250, 260. Structure 200 may also optionally include an insulating layer 270 and/or 280, and/or a second substrate 295.

Structures 100 and 200 may be used to store information and thus may be used in memory circuits. For example, structures 100, 200, or other programmable structures in accordance with the present invention, may suitably be used in memory devices to replace DRAM, SRAM, PROM, EPROM, EEPROM devices, or any combination of such memory. In addition, programmable structures of the present invention may be used for other applications where programming or changing of electrical properties of a portion of an electrical circuit are desired. As described in more detail below, structures 100 and 200 may also be used to form electrical connections or shorts between portions of a device, between devices, chip to chip, chip to package, package to package, package to printed circuit board, printed circuit board to printed circuit board, device/chip/package/board connections to wiring or flexible circuits, any combination thereof, and the like.

Referring again to FIGS. 1 and 2, substrate 110, 210 may include any suitable material. For example, substrate 110, 210 may include semiconductive, conductive, semiinsulative, insulative material, or any combination of such materials, and may be rigid, semi-rigid, or flexible. In accordance with one embodiment of the invention, substrate 210 includes an insulating material 270 and a portion 215 including a microelectronic device formed using a portion of the substrate. Layer 270 and portion 215 may be separated by additional layers (not shown) such as, for example, layers typically used to form integrated circuits.

In accordance with alternative exemplary embodiments, substrate 110, 210 includes flexible material, such as flexible display substrate material (e.g., plastic and polymer films), flexible circuit substrate material, (e.g., plastic, such as polyimide or peek films), or RFID tag substrate material. In accordance with additional embodiments, substrate 110, 210 includes a chip, a package, or a printed circuit board.

Electrodes 120, 220 and 130, 230 may be formed of any suitable conductive material. For example, electrodes 120, 220 and 130, 230 may be formed of doped polysilicon material, metal, metal silicides, and metal nitrides. In accordance with various exemplary embodiments, one or both of electrodes 120, 220 and 130, 230 are formed from a liquid source (e.g., a conductive ink or conductive polymer) using a printing process. Exemplary metal inks include metallic particles, such as silver or copper flakes or carbon material, in a retaining matrix. The matrix may be a polymer, which solidifies (e.g., at a temperature of about 150° C.) and which is conductive. Exemplary conductive polymers suitable for use in accordance with various exemplary embodiments include poly (2,4-ethylene dioxxthiophene) poly (styrenesulfonate) (PE 007: PSS).

In accordance with one exemplary embodiment of the invention, one of electrodes 120, 220 and 130, 230 is formed of a material including a material (e.g., metal) that is oxidizable, soluble in ion conductor 140, 240, electrochemically active, or a combination thereof, when a sufficient bias (V≧VT) is applied across the electrodes (a soluble or an oxidizable electrode) and the other electrode is relatively inert and does not dissolve during operation of the programmable device (an inert or indifferent electrode). For example, electrode 120, 220 may be an anode during a write process and be comprised of a material including silver or copper that dissolves in ion conductor 140, 240 and electrode 130, 230 may be a cathode during the write process and be comprised of an inert material such as tungsten, nickel, molybdenum, metal silicides, noble metals, including platinum, ruthenium, irridium, transition metals, including titanium, metal silicides, and metal nitrides, including tungsten nitride, titanium nitride, and the like. Having at least one electrode formed of a material including a metal, which dissolves in ion conductor 140, 240 facilitates maintaining a desired dissolved metal concentration within ion conductor 140, 240, which in turn facilitates rapid and stable region 170, 290 formation within ion conductor 140, 240 or other electrical property change during use of structure 100 and/or 200. Furthermore, use of an inert material for the other electrode (cathode during a write operation) facilitates electrodissolution of any region 170, 290 that may have formed and/or return of the programmable device to an erased state after application of a sufficient voltage. Additional electrode materials are disclosed in U.S. Pat. No. 6,927,411, the relevant portions of which are hereby incorporated herein by reference.

As noted above, programmable structures of the present invention may include one or more barrier or buffer layers 150, 160 and 250, 260 interposed between at least a portion of ion conductor 140 and one of the electrodes 120, 130. Although illustrated as covering only a portion of ion conductor 140, the barrier or buffer layers may cover additional surfaces—e.g., such that the barrier or buffer layer covers a top portion of the respective electrode. Suitable materials for layers 150, 160, 250, 260 are disclosed in U.S. Pat. No. 6,927,411, which is incorporated by reference.

Ion conductor 140, 240 is formed of material that conducts ions upon application of a sufficient voltage. In general, ion conductors in accordance with the present invention can conduct ions without requiring a phase change, can conduct ions at a relatively low temperature (e.g., below 125° C.), can conduct ions at relatively low electrical currents, have a relatively high transport number, and exhibit relatively high ion conductivity.

In accordance with various exemplary embodiments of the invention, ion conductor 140, 240 is formed from a liquid source. By way of example, ion conductor 140, 240 may be formed using a liquid glass (e.g., spin-on-glass (SOG)) technology, which typically employs polysiloxanes or methylsilsesquioxane (MSQ) as a precursor or starting material, and which typically cure at about 150° C.

Referring again to FIG. 2, in accordance with one exemplary embodiment of the invention, at least a portion of structure 200 is formed within a via of an insulating material 280. Forming a portion of structure 200 within a via of an insulating material 280 may be desirable because, among other reasons, such formation allows relatively small structures to be formed. In addition, insulating material 280 facilitates isolating various structures 200 from other electrical components.

Insulating material 280 suitably includes material that prevents undesired diffusion of electrons and/or ions from structure 200. In accordance with one embodiment of the invention, material 280 includes silicon nitride, silicon oxynitride, polymeric materials such as polyimide or parylene, or any combination thereof.

Although not illustrated, structure 100 may suitably include insulating materials described herein and both structures may be suitably encapsulated.

Structures 100, 200 may additionally include contacts (not illustrated) to form electrical connections to electrodes 120, 220 and 130, 230. The contacts may be formed of any conductive material and are preferably formed of a metal, alloy, or composition including aluminum, tungsten, or copper.

As noted above, one or more of electrodes 120, 220 and 130, 230 and ion conductor 140, 240 are formed using printing technology. Use of printing technology may be desirable because it allows for relatively inexpensive, high through-put processing of structures 100, 200.

Exemplary printing techniques suitable for forming one or more of electrodes 120, 220 and 130, 230, and/or ion conductor 140, 240 include ink jet printing, screen printing, stamping, lithographic printing, dip pen, and nozzle applicator printing techniques, which use liquid precursors, such as those described above. These techniques can be combined with other techniques to form the electrodes and the ion conductor, such as the methods described in U.S. Pat. No. 6,927,411, which is incorporated by reference.

As will be appreciated, structures 100, 200 may be formed in a variety of configurations. The examples provided below are merely illustrative and are not meant to be limiting. Various other configurations are also included within the scope of the invention.

1. Symmetric Device

In accordance with exemplary embodiments of the invention, a structure (e.g., structure 100 or 200) is configured such that both electrodes 120, 220 and 130, 230 are formed of active or oxidizable material. In accordance with various aspects of these embodiments, the electrodes are formed by printing Ag or Cu electrodes, which each contribute conductive material to formation of conductive region 170, 290. By way of particular example, in the case of structure 200, electrode 220 is formed on substrate 210 (e.g., using printing technology), ion conductor material 240 is deposited onto electrode 220 (e.g., using printing or liquid glass (e.g., SOG)). Then, electrode 230 material is deposited onto ion conductor 240 to form programmable structure 200 (e.g., using printing technology). Barrier or buffer layers 250, 260 may be similarly formed using printing technology or other techniques.

With reference to FIG. 1, a symmetric lateral device may be formed by first printing an ion conductor 140 on substrate 100 and then printing electrodes 120, 130 onto portions of ion conductor 140. Alternatively electrodes 120, 130 may be printed onto substrate 110 and ion conductor 140 may be printed overlying portions of electrodes 120, 130.

2. Non-Symmetric Device

In accordance with these exemplary embodiments, a structure (e.g., structure 100, 200) includes one active or oxidizable electrode and one inert or inactive electrode. The inert electrode may be formed of any conductive material that does not dissolve into ion conductor 140, 240 upon application of a “write” voltage. Non-symmetric structures 100, 200 may be formed as discussed above in connection with symmetric devices, in either a vertical or horizontal configuration.

3. Doped Electrolyte

In accordance with additional embodiments of the invention, ion conductor 140, 240 is formed by printing a bilayer of ion conductive material and conductive material. Conductive material is diffused into ion conductive material using heat, light, or supplying a sufficient bias, as described in U.S. Pat. No. 6,927,411, which is incorporated by reference.

In accordance with various aspects of these embodiments, ion conductor material is initially deposited and conductive material is deposited onto the ion conductor material. In accordance with alternative embodiments, the conductive material is deposited first and ion conductor material is deposited overlying the conductive material. The conductive material may be deposited using printing techniques, spin-on techniques, spraying, sol-gel techniques, solution techniques, or the like.

In accordance with alternative embodiments of the invention, a doped ion conductor is formed by printing a mixture of ion conductor material (e.g., SiOₓ) and conductive material (e.g., Ag- or Cu-containing inks).

In accordance with additional embodiments of the invention, the electrodes are formed during ion conductor 140 doping by depositing sufficient metal onto an ion conductor material and applying sufficient electrical, thermal, or photonic energy to the layers, such that a portion of the metal is dissolved within the ion conductor material and a portion of the metal remains on a surface of the ion conductor to form an electrode (e.g., electrode 230). Regions of differing conductivity within ion conductor 240 can be formed using this technique by applying a sufficient amount of energy to the structure such that a first portion of the ion conductor proximate the soluble electrode contains a greater amount of conductive material than a second portion of the ion conductor proximate the indifferent electrode. This process is self limiting if the ion conductor material layer is thick enough so that a portion of the film becomes saturated and a portion of the film is unsaturated.

An amount of conductive material such as metal dissolved in an ion conductor material may depend on several factors such as an amount of metal available for dissolution and an amount of energy applied during the dissolution process. However, when a sufficient amount of metal and energy are available for dissolution in the ion conductor material using photodissolution, the dissolution process is thought to be self limiting, substantially halting when the metal cations have been reduced to their lowest oxidation state.

As noted above, programmable structures in accordance with various embodiments may be used to store information. Information may be stored using programmable structures of the present invention by manipulating one or more electrical properties of the structures. For example, a resistance or capacitance of a structure may be changed from a “0” or off state to a “1” or on state during a suitable write operation. Similarly, the device may be changed from a “1” state to a “0” state during an erase operation. In addition, as discussed in more detail below, the structure may have multiple programmable states such that multiple bits of information are stored in a single structure.

Write Operation

Current through a structure (e.g., structure 100, 200) in an off state begins to rise upon application of a bias of over about several hundred millivolts; however, once a write step has been performed (i.e., a conductive region or an electrodeposit has formed), the resistance through ion conductor 140, 240 drops significantly (i.e., to a value between a few hundred ohms and a few hundred thousand ohms). As noted above, when electrode 120, 220 is coupled to a more negative end of a voltage supply, compared to electrode 130, 230, a conductive region begins to form near electrode 120, 220 and grows toward electrode 130, 230. In cases where the structure includes an insulating barrier, an effective threshold voltage (i.e., voltage required to cause growth of the conductive region and to break through the barrier (e.g., barriers 150, 250 and 160, 260), thereby coupling electrodes 120, 130 together) is relatively high because of the barrier. In particular, a voltage V≧V_{T} must be applied to structure 200 sufficient to cause electrons to tunnel through the barrier to form the conductive region and to overcome the barrier (e.g., by tunneling through or leakage) and conduct through ion conductor 140 and at least a portion of the barrier.

In accordance with alternate embodiments of the invention, where no insulating barrier layer is present, an initial “write” threshold voltage is relatively low because no insulative barrier is formed between, for example, ion conductor 140 and either of the electrodes 120, 220 and 130, 230.

As noted above, the relative volatility of the memory structures of the present invention may be altered by applying different amounts of energy to the structures during a write process. For example, a relatively high current pulse of a few hundred microamperes for a period of about several hundred nanoseconds may be applied to the structures illustrated in FIGS. 1 and 2 to form a relatively nonvolatile memory cell. Alternatively, the same current may be supplied to the same or similar memory structure for a shorter amount of time, e.g., several nanoseconds to form a relatively volatile memory structure. In either case, the memory of the present invention can be programmed at relatively high speeds and even the “volatile” memory is relatively nonvolatile compared to traditional DRAM. For example, the volatile memory may operate at speed comparable to DRAM and only require refreshing every several hours.

Read Operation

A state of a memory cell (e.g., 1 or 0) may be read, without significantly disturbing the state, by, for example, applying a forward or reverse bias of magnitude less than a voltage threshold for electrodeposition or by using a current limit which is less than or equal to the minimum programming current (the current which will produce the highest of the “on” resistance values). By way of particular example, in the case of a current limited (to about 1 milliamp) read operation, the voltage is swept from 0 to about 2 V and the current rises up to the set limit (from 0 to 0.2 V), indicating a low resistance (ohmic/linear current-voltage) “on” state. Another way of performing a non-disturb read operation is to apply a pulse, with a relatively short duration, which may have a voltage higher than the electrochemical deposition threshold voltage, such that no appreciable Faradaic current flows, i.e., nearly all the current goes to polarizing/charging the device and not into the electrodeposition process.

In accordance with various embodiments of the invention, circuits including the programmable structures include temperature compensation devices to mitigate effects of temperature variation on the performance of the programmable device. One exemplary temperature compensation circuit includes a programmable structure having a known erased state. In this case, during a read operation, a progressively increasing voltage is applied to a programmable structure having an unknown state as well as to the structure having the known erased state. If the unknown structure has been written to, it will switch on before the known erased device and if the unknown structure is in an erased state, the two devices will switch on at approximately the same time. Alternatively, a temperature compensation circuit can be used to produce a comparison voltage or current to be compared to a voltage or current produced by a programmable structure of an unknown state during a read process.

Erase Operation

A programmable structure (e.g., structure 100, 200) may suitably be erased by reversing a bias applied during a write operation, wherein a magnitude of the applied bias is equal to or greater than the threshold voltage for electrodeposition in the reverse direction. In accordance with an exemplary embodiment of the invention, a sufficient erase voltage (V≧V_{T}) is applied to a structure for a period of time, which depends on energy supplied during the write operation, but is typically less than about 1 millisecond to return the structure to its “off” state having a resistance well in excess of a million ohms. Alternatively, a device may be erased by applying a high current pulse, with a current and a voltage direction the same as that used for a write process.

Pulse Mode Read/Write

In accordance with an alternate embodiment of the invention, pulse mode programming is used to write to and read from a programmable structure. In this case, similar to the process described above, region 170, 290 forms during a write process; however, unlike the process described above, at least a portion region 170, 290 is removed or dissolved during a read operation. During an erase/read process, the magnitude of the current pulse is detected to determine the state (1 or 0) of the device. If the device had not previously been written to or has previously been erased, no ion current pulse will be detected at or above the reduction/oxidation potential of the structure. But, if the device is in a written state, an elevated current will be detected during the destructive read/erase step. Because this is a destructive read operation, information must be written to each structure after each read process—similar to DRAM read/write operations. However, unlike DRAM devices, the structures of the present invention are stable enough to allow a range of values to be stored. Thus, a partially destructive read that decreases, but does not completely eliminate region 170, 290, can be used. In accordance with an alternate aspect of this embodiment, a destructive write process rather than a destructive erase process can be used read the device. In this case, if the cell is in an “off” state, a write pulse will produce an ion current spike as region 170, 290 forms, whereas a device that already includes a region 170, 290 will not produce the ion current spike if the process has been limited by a lack of oxidizable material.

Control of Operational Parameters

The concentration of conductive material in the ion conductor can be controlled by applying a bias across the programmable device. For example, metal such as silver may be taken out of solution by applying a negative voltage in excess of the reduction potential of the conductive material. Conversely, conductive material may be added to the ion conductor (e.g., from one of the electrodes) by applying a bias in excess of the oxidation potential of the material. Thus, for example, if the conductive material concentration is above that desired for a particular device application, the concentration can be reduced by reverse biasing the device to reduce the concentration of the conductive material. Similarly, metal may be added to the solution from the oxidizable electrode by applying a sufficient forward bias. Additionally, it is possible to remove excess metal build up at the indifferent electrode by applying a reverse bias for an extended time or an extended bias over that required to erase the device under normal operating conditions. Control of the conductive material may be accomplished automatically using a suitable microprocessor.

The threshold voltage of programmable devices may be manipulated in accordance with various embodiments of the present invention. Manipulation of the threshold voltage allows configuration of the programmable devices for desired read and write voltages. In general, the threshold voltage depends on, among other things, an amount of conductive material present in the ion conductor and/or any barrier, as set forth in U.S. Pat. No. 6,927,411, which is incorporated herein.

In accordance with yet additional embodiments of the invention, multiple bits of data may be stored within a single programmable structure by controlling a size of region 170, 290, which is formed during a write process. A size of region 170, 190 that forms during a write process depends on a number of coulombs or charge supplied to the structure during the write process, and may be controlled by using a current limit power source. In this case, a resistance of a programmable structure is governed by Equation 1, where Rₒₙ, is the “on” state resistance, V_{T} is the threshold voltage for electrodeposition, and I_{LIM} is the maximum current allowed to flow during the write operation.

$${R}_{on} = \frac{{V}_{T}}{{I}_{LIM}} \qquad Equation 1$$

In practice, the limitation to the amount of information stored in each cell will depend on how stable each of the resistance states is with time. For example, if a structure with a programmed resistance range of about 3.5 kΩ and a resistance drift over a specified time for each state is about ±250 Ω, about 7 equally sized bands of resistance (7 states) could be formed, allowing 3 bits of data to be stored within a single structure. In the limit, for near zero drift in resistance in a specified time limit, information could be stored as a continuum of states, i.e., in analog form.

A programmable structure in accordance with the present invention may be used in many applications which would otherwise utilize traditional technologies such as EEPROM, FLASH or DRAM. Additionally, the ionic structures can be used in programmable interconnect systems to form electrical connections between portions of a device and between devices.

Advantages provided by the programmable structures of the present invention over present programmable structures include, among other things, lower production cost and the ability to use flexible fabrication techniques which are easily adaptable to a variety of applications. The programmable structures of the present invention are especially advantageous in applications where cost is the primary concern, such as smart cards and electronic inventory tags. Also, an ability to form the ionic structure directly on a plastic card or other flexible substrate is a major advantage in these applications as this is generally not possible with other forms of semiconductor memories.

Ionic structures and devices and systems including the structures described herein are advantageous over traditional structures and devices because the ionic structures require relatively little internal voltage to perform write and erase functions, require relatively little current to perform the write and erase functions, are relatively fast (both write and read operations), require little to no refresh (even for “volatile” memory applications), can be formed in high-density arrays, are relatively inexpensive to manufacture, are robust and shock resistant, and do not require a monocrystalline starting material and can therefore be formed on flexible substrates.

Although the present invention is set forth herein in the context of the appended drawing figures, it should be appreciated that the invention is not limited to the specific form shown. Various modifications, variations, and enhancements in the design and arrangement of the method and apparatus set forth herein may be made without departing from the spirit and scope of the present invention as set forth in the appended claims.

I claim:

1. A method of forming an ionic structure, the method comprising the steps of:
providing a substrate;
forming a first electrode overlying the substrate;
forming an ion conductor proximate the first electrode; and
forming a second electrode proximate the ion conductor, wherein at least one of the step of forming a first electrode, the step of forming an ion conductor, and the step of forming a second electrode is performed using a printing technique.

2. The method of forming an ionic structure of claim 1, wherein the ion conductor is formed using a liquid glass precursor.

3. The method of forming an ionic structure of claim 1, wherein the step of forming a first electrode comprises depositing a conductive ink.

4. The method of forming an ionic structure of claim 3, wherein the step depositing a conductive ink comprises printing the ink using a technique selected from the group consisting of ink jet printing, screen printing, stamping, lithographic printing, dip-pen printing, and nozzle-applicator pen.

5. The method of forming an ionic structure of claim 1, wherein the step of forming a second electrode comprises depositing a conductive ink.

6. The method of forming an ionic structure of claim 5, wherein the step depositing a conductive ink comprises printing the ink using a technique selected from the group consisting of ink jet printing, screen printing, stamping, lithographic printing, dip-pen printing, and nozzle-applicator pen.

7. The method of forming an ionic structure of claim 1, wherein the step of forming an ion conductor further comprises the steps of depositing ion conductor material, depositing conductive material, and dissolving at least a portion of the conductive material in the ion conductor material.

8. The method of forming an ionic structure of claim 1, wherein the step of forming an ion conductor comprises the step of codepositing ion conductor material and conductive material.

9. The method of forming an ionic structure of claim 1, wherein the ionic structure is formed as a lateral structure.

10. The method of forming an ionic structure of claim 1, wherein the ionic structure is formed as a vertical structure.

11. The method of forming an ionic structure of claim 1, wherein the first electrode comprises inert material and the second electrode comprises material having a property selected from the group of oxidizable, soluble in the ion conductor, electrochemically active, and a combination thereof.

12. The method of forming an ionic structure of claim 1, wherein the first electrode comprises material having a property selected from the group of oxidizable, soluble in the ion conductor, electrochemically active, and a combination thereof and the second electrode comprises material having a property selected from the group of oxidizable, soluble in the ion conductor, electrochemically active, and a combination thereof.

13. The method of forming an ionic structure of claim 1, further comprising the step of applying a bias across the first electrode and the second electrode to cause as least a portion of the first electrode to dissolve in the ion conductor.

14. The method of forming an ionic structure of claim 1, further comprising the step of forming a barrier layer between the ion conductor and one of the first electrode and the second electrode.

15. The method of forming an ionic structure of claim 1, wherein the step of providing a substrate comprises providing a flexible substrate.

16. A method of forming an ionic structure, the method comprising the steps of:
providing a substrate;
printing a first electrode overlying the substrate;
printing an ion conductor proximate the first electrode; and
printing a second electrode proximate the ion conductor.

17. A method of forming an electrical connection comprising the steps of:
providing a substrate;
forming a first electrode overlying the substrate;
forming an ion conductor proximate the first electrode;
forming a second electrode proximate the ion conductor; and
applying a sufficient bias across the first electrode and the second electrode to form an electrical connection between the first electrode and the second electrode, wherein at least one of the step of forming a first electrode, the step of forming an ion conductor, and the step of forming a second electrode is performed using a printing technique.

18. The method of forming an electrical connection of claim 17, further comprising the step of providing a second substrate.

19. The method of forming an electrical connection of claim 17, wherein the printing technique comprises a process selected from the group consisting of ink jet printing, screen printing, stamping, lithographic printing, dip-pen printing, and nozzle-applicator pen.

20. The method of forming an electrical connection of claim 17, wherein the ion conductor is formed using a liquid glass.
